(19) United States
(12) Patent Application Publication
(10) Pub. No.: US 2003/0012327 A1
(43) Pub. Date: Jan. 16, 2003

(54) Upper guide structure for simplification of refueling procedure in nuclear power plant

(76) Inventors: Jeong-Ki Hwang, Daejon (KR); Dae-Heon Lim, Cheongju (KR); Cheol-Soo Maeng, Daejon (KR); Min-Gyu Kim, Daejon (KR); Heuy-Gap Song, Daejon (KR); Jae-Hyun Bae, Daejon (KR); Sang-Gyoon Chang, Daejon (KR)

Correspondence Address: NIXON & VANDERHYE P.C., 8th Floor, 1100 North Glebe Rd., Arlington, VA, 22201-4714, US

(21) Appl. No.: 10/191,552

(22) Filed: Jul. 10, 2002

(30) Foreign Application Priority Data
Jul. 13, 2001 (KR) 2001-42297

(51) Int. Cl. G21C 19/00

(52) U.S. Cl. 376/261

(57) ABSTRACT

An upper guide structure for simplification of a refueling procedure in a nuclear power plant includes an upper guide cylinder inserted in an upper end portion of a core support barrel installed inside a nuclear reactor vessel to guide a control rod assembly, a support plate installed at a lower end of the upper guide cylinder and having a plurality of first control rod insertion holes formed therein, hollow control rod assembly upper guide tubes respectively installed in the first control rod insertion holes, and a nuclear fuel alignment plate installed at lower ends of the control rod assembly upper guide tubes and including a plurality of second control rod insertion holes formed at positions corresponding to the control rod assembly upper guide tubes, each of the second control rod insertion holes having an inner diameter which increases to an lower end thereof so that the nuclear fuel assembly guide rod is inserted even when a position alignment error of the nuclear fuel assembly is great, and first cooling water paths formed between the second control rod insertion holes.

### BACKGROUND OF THE INVENTION

1. Field of the Invention

The present invention relates to an upper guide structure for the simplification of a refueling procedure in a nuclear power plant, and more particularly to an upper guide structure for the simplification of a refueling procedure in a nuclear power plant by which the position of a control rod can be easily aligned to the position of a nuclear fuel assembly when a control rod assembly is inserted into the nuclear fuel assembly after the nuclear fuel assembly is refueled in a nuclear reactor vessel.

2. Description of the Related Art

FIG. 10 shows the structure of a typical nuclear reactor used in a nuclear power plant. The nuclear reactor of a nuclear power plant includes a nuclear reactor vessel 1 and a closure head 5 opening and shutting the reactor vessel 1. A core support barrel 2 is installed in the nuclear reactor vessel 1 and a nuclear fuel assembly 3 is loaded in the lower portion in the core support barrel 2. The nuclear fuel assembly 3, as shown in FIGS. 11 and 12, has a nuclear fuel assembly guide rod 3a protruding upward. An upper guide structure 4 for guiding a control rod assembly connected to a control rod assembly connection shaft 6 is installed above the nuclear fuel assembly 3.

The upper guide structure 4, as shown in FIG. 13, includes an upper guide cylinder 41 inserted in the core support barrel 2 in a state in which an upper flange 41a is supported by the upper end of the core support barrel 2, a support plate 42 installed at the lower end of the upper guide cylinder 41, hollow control rod assembly upper guide tubes 43 which are inserted in the support plate 42 and protrude downward, a nuclear fuel alignment plate 44 installed at the lower ends of the control rod assembly upper guide tubes 43, and hollow control rod assembly lower guide tubes 45 which are inserted in control rod insertion holes 44a (refer to FIG. 14) and protrude downward, each having the same diameter as that of each control rod assembly upper guide tube 43. The control rod insertion holes 44a are formed in the nuclear fuel alignment plate 44 at the positions corresponding to the control rod assembly upper guide tubes 43. Also, a cooling water path 44b (refer to FIG. 14) through which cooling water for cooling heat generated during disintegration of the nuclear fuel assembly 3 flows is formed between each of the neighboring control rod insertion holes 44a.

The upper guide structure 4 is installed above the nuclear fuel assembly 3 in a state in which the nuclear fuel assembly guide rod 3a is inserted in the lower end portion of the control rod assembly lower guide tube 45.

If the upper guide structure 4 is installed such that the nuclear fuel assembly guide rod 3a is not inserted in the control rod assembly lower guide tube 45, the nuclear fuel assembly 3 is damaged. Also, if the nuclear reactor is operated after the upper guide structure 4 is installed such that the nuclear fuel assembly guide rod 3a is not accurately inserted in the control rod assembly lower guide tube 45, that is, when accurate position match is not made, the control rod cannot be inserted in the nuclear fuel assembly 3. In this case, since a nuclear critical reaction of the nuclear fuel assembly 3 cannot be controlled by the control rod, which may cause a disaster, the upper guide structure 4 is taken back from the nuclear reactor vessel 1 and the nuclear fuel assembly 3 is inconveniently realigned and the upper guide structure 4 is reinstalled.

In consideration of the above problem, in order for the nuclear fuel assembly guide rod 3a to be easily inserted in the lower end portion of the control rod assembly lower guide tube 45 even when the center line of the nuclear fuel assembly guide rod 3a is slightly deviated from the center line of the control rod assembly lower guide tube 45, as shown in FIGS. 11 and 12, the upper end of the nuclear fuel assembly guide rod 3a is tapered and the lower end portion of the control rod assembly lower guide tube 45 is processed to have an inner diameter which gradually increases toward the lowest end thereof. By doing so, when the amount of deviation of the center line of the control rod assembly lower guide tube 45 with respect to the center line of the nuclear fuel assembly guide rod 3a is within an allowance corresponding to the amount of increase of the inner diameter by the inner diameter expansion process, the nuclear fuel assembly guide rod 3a can be inserted in the control rod assembly lower guide tube 45.

However, even when the inner diameter of the lower end portion of the control rod assembly lower guide tube 45 is increased by the inner diameter expansion process, the inner diameter of the lowest end portion of the control rod assembly lower guide tube 45, that is, the maximum inner diameter, is necessarily smaller than the outer diameter of the control rod assembly lower guide tube 45. That is, the amount of allowable deviation of the center line of the control rod assembly lower guide tube 45 with respect to the nuclear fuel assembly guide rod 3a is unavoidably restricted to be less than the thickness of the control rod assembly lower guide tube 45.

According to the conventional upper guide structure 4, since the amount of allowable deviation of the center line of the control rod assembly lower guide tube 45 with respect to the nuclear fuel assembly guide rod 3a is limited to a very small range, during the installation of the upper guide structure 4, the possibility of the nuclear fuel assembly guide rod 3a not being accurately inserted in the control rod assembly lower guide tube 45 is not reduced much. As a result, a position alignment work between the nuclear fuel assembly 3 and the upper guide structure 4 must be inconveniently performed with a high accuracy by using lots of time and efforts in advance before the upper guide structure 4 is installed.

### SUMMARY OF THE INVENTION

To solve the above-described problems, it is an object of the present invention to an upper guide structure for the simplification of a refueling procedure in a nuclear power plant which enables a simply and easy alignment between the control rod and the nuclear fuel assembly when the control rod assembly is inserted into the nuclear fuel assembly after the nuclear fuel assembly is refueled in the nuclear reactor vessel.

To achieve the above object, there is provided an upper guide structure for simplification of a refueling procedure in a nuclear power plant, which comprises an upper guide cylinder inserted in an upper end portion of a core support barrel installed inside a nuclear reactor vessel to guide a control rod assembly, a support plate installed at a lower end of the upper guide cylinder and having a plurality of first control rod insertion holes formed therein, hollow control rod assembly upper guide tubes respectively installed in the first control rod insertion holes, and a nuclear fuel alignment plate installed at lower ends of the control rod assembly upper guide tubes and including a plurality of second control rod insertion holes formed at positions corresponding to the control rod assembly upper guide tubes, each of the second control rod insertion holes having an inner diameter which increases to an lower end thereof so that the nuclear fuel assembly guide rod is inserted even when a position alignment error of the nuclear fuel assembly is great, and first cooling water paths formed between the second control rod insertion holes.

It is preferred in the present invention that the upper guide structure further comprises second cooling water paths formed in a bottom surface of the nuclear fuel alignment plate to connect in a lateral direction the first cooling water paths and the second control rod insertion holes which are adjacent to each other.

It is preferred in the present invention that the nuclear fuel alignment plate is formed to have a plate shape or tray shape which has a flange extending upward from en edge thereof and bent outside.

To achieve the above object, there is provided an upper guide structure for simplification of a refueling procedure in a nuclear power plant, which comprises an upper guide cylinder inserted in an upper end portion of a core support barrel installed inside a nuclear reactor vessel to guide a control rod assembly, a support plate installed at a lower end of the upper guide cylinder and having a plurality of first control rod insertion holes formed therein, hollow control rod assembly upper guide tubes respectively installed in the first control rod insertion holes, a nuclear fuel alignment plate installed at lower ends of the control rod assembly upper guide tubes and including a plurality of second control rod insertion holes formed at positions corresponding to the control rod assembly upper guide tubes, and first cooling water paths formed between the second control rod insertion holes, hollow control rod assembly lower guide tubes respectively inserted in the second control rod insertion holes to protrude downward, and nuclear fuel assembly guide rod insertion bodies provided at lower ends of the control rod assembly lower guide tubes to connect the hollow control rod assembly lower guide tubes, and having third control rod insertion holes formed to have an inner diameter increasing to a lower end thereof so that the nuclear fuel assembly guide rod is inserted even when a position alignment error of the nuclear fuel assembly is great.

It is preferred in the present invention that third cooling water paths connected to the third control rod insertion holes are formed in a bottom surface of the nuclear fuel assembly guide rod insertion bodies.

It is preferred in the present invention that upper ends of the nuclear fuel assembly guide rod insertion bodies contact the bottom surface of the nuclear fuel alignment plate.

It is preferred in the present invention that the nuclear fuel assembly guide rod insertion bodies are integrally formed with the control rod assembly lower guide tubes.

While this invention has been particularly shown and described with reference to preferred embodiments thereof, it will be understood by those skilled in the art that various changes in form and details may be made therein without departing from the spirit and scope of the invention as defined by the appended claims.

### BRIEF DESCRIPTION OF THE DRAWINGS

The above object and advantages of the present invention will become more apparent by describing in detail preferred embodiments thereof with reference to the attached drawings in which:

FIG. 1 is a sectional view showing an upper guide structure according to a first preferred embodiment of the present invention;

FIG. 2 is a sectional view showing major portions of the upper guide structure shown in FIG. 1;

FIG. 3 is a bottom view of the nuclear fuel alignment plate shown in FIG. 2;

FIG. 4 is a sectional view showing major portions of an upper guide structure according to a second preferred embodiment of the present invention;

FIG. 5 is a sectional view showing major portions of an upper guide structure according to a third preferred embodiment of the present invention;

FIG. 6 is a sectional view showing another example of the upper guide structure according to the third preferred embodiment of the present invention;

FIG. 7 is a bottom view of the nuclear fuel alignment plate shown in FIG. 5;

FIG. 8 is a sectional view showing major portions of an upper guide structure according to a fourth preferred embodiment of the present invention;

FIG. 9 is a sectional view showing another example of the upper guide structure according to the fourth preferred embodiment of the present invention;

FIG. 10 is a section view showing the structure of a typical nuclear reactor;

FIG. 11 is a front view showing the nuclear fuel assembly shown in FIG. 10;

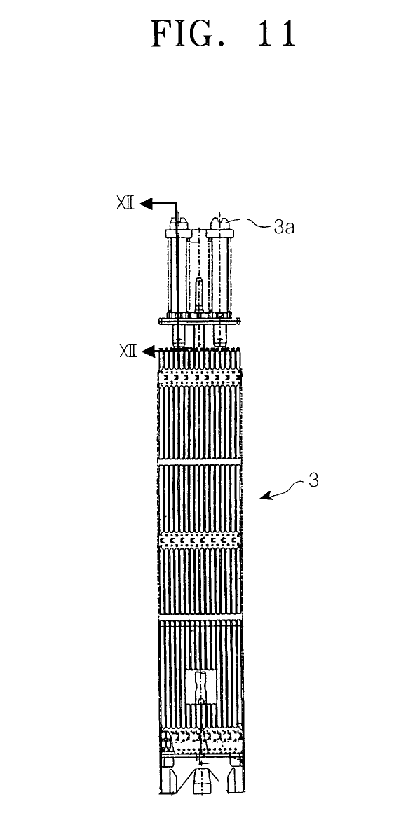

FIG. 12 is a sectional view taken along line XII-XII of FIG. 11;

FIG. 13 is a sectional view showing the conventional upper guide structure; and

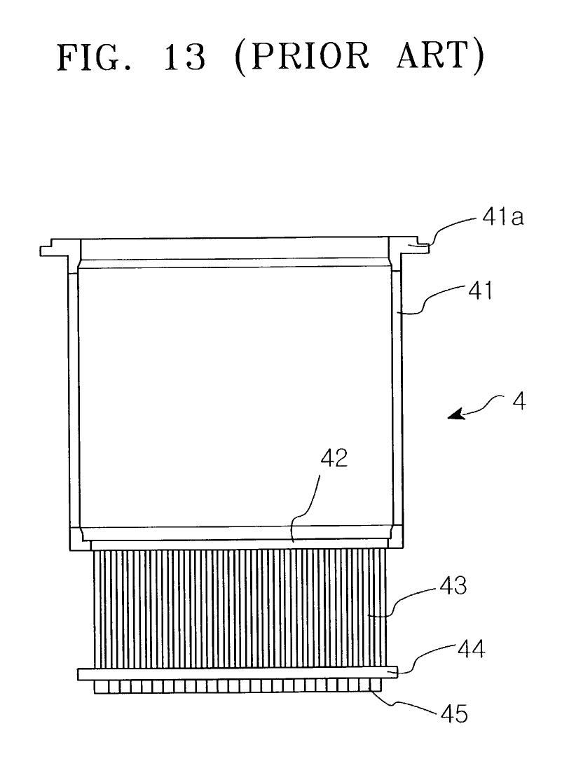

FIG. 14 is a sectional view showing major portions of the conventional upper guide structure.

### DETAILED DESCRIPTION OF THE INVENTION

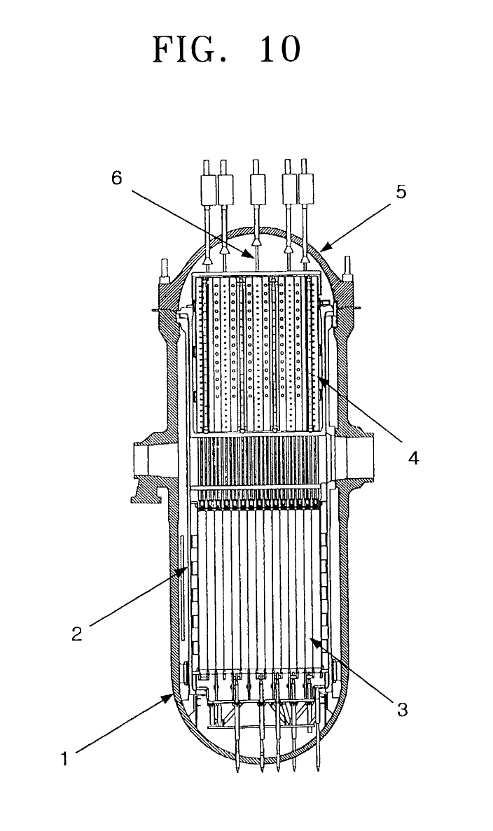

In the preferred embodiments of the present invention, the same reference numerals shown in FIG. 10 indicate the same elements.

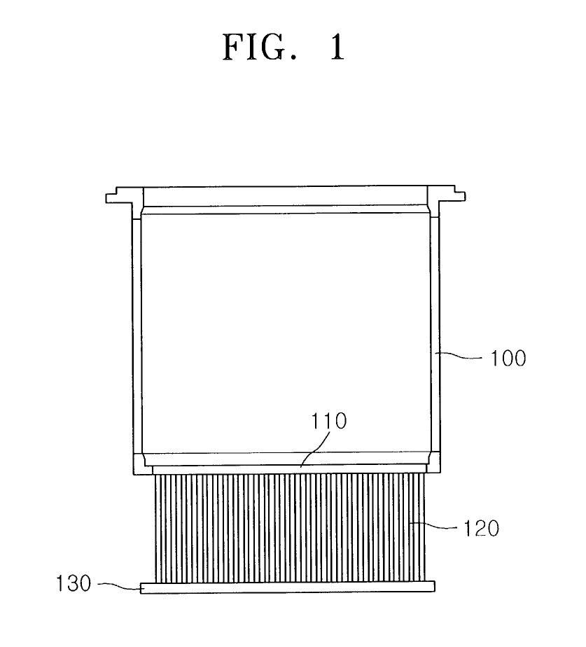

Referring to FIGS. 1 through 3, an upper guide structure according to a first preferred embodiment of the present invention includes an upper guide cylinder 100 for guiding the control rod assembly 6 by being inserted in the upper end portion of the core support barrel 2 installed in the nuclear reactor vessel 1, a support plate 110 installed at the lower end of the upper guide cylinder 100 and having a plurality of first control rod insertion holes 111 formed therein, a plurality of hollow control rod assembly upper guide tubes 120 inserted in the first control rod insertion holes 111 and protruding downward, and a nuclear fuel alignment plate 130 installed at the lower end of the control rod assembly upper guide tubes 120.

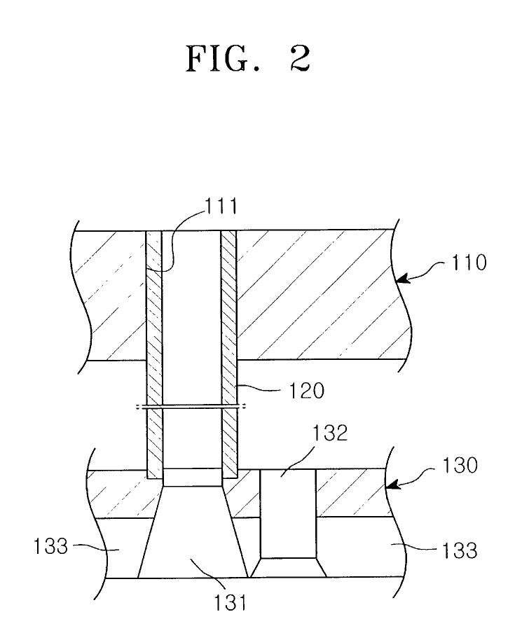

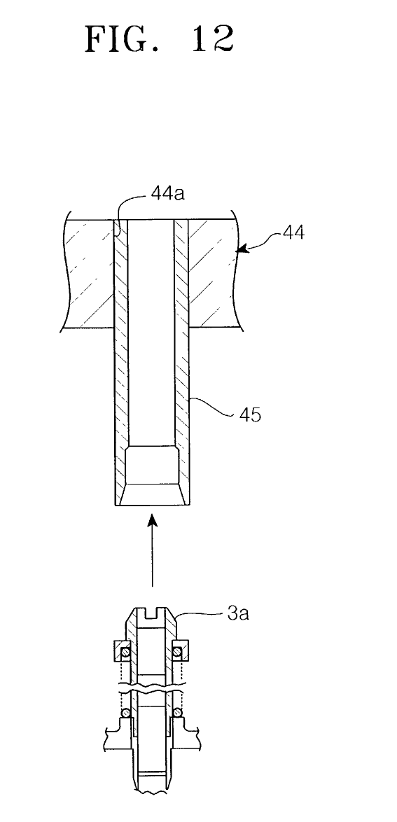

The nuclear fuel alignment plate 130, as shown in FIG. 2, is preferably formed of a plate. A plurality of second control rod insertion holes 131 are formed in the nuclear fuel alignment plate 130 at positions corresponding to the control rod assembly upper guide tubes 120. In the present preferred embodiment, each of the second control rod insertion holes 131 is formed to have a funnel shape whose diameter increases from the upper side to the lower side, so that the nuclear fuel assembly guide rod 3a (refer to FIG. 12) can be well inserted even when a position alignment error of the nuclear fuel assembly 3 is great. A first cooling water path 132 through which cooling water for cooling heat generated during disintegration of the nuclear fuel assembly 3 flows is formed between each of the neighboring second control rod insertion holes 131.

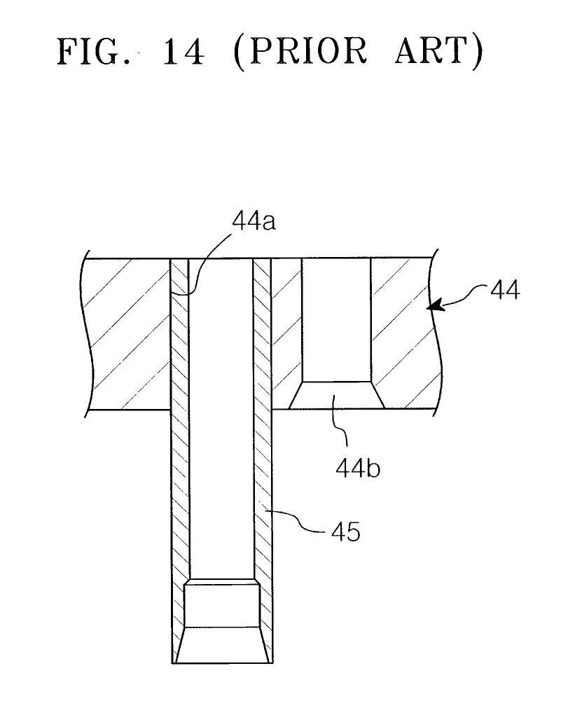

According to the present preferred embodiment, since each of the second control rod insertion holes 131 is formed to have a funnel shape, the inner diameter of the lower end of the second control rod insertion hole 131 is quite greater than the outer diameter of the upper end of the nuclear fuel assembly guide rod 3a. That is, since the second control rod insertion hole 131 is formed in the nuclear fuel alignment plate 130, the maximum inner diameter of the second control rod insertion hole 131, that is, the inner diameter of the lowest end thereof, can be formed to be greater than the outer diameter of the control rod assembly lower guide tube 45 (refer to FIG. 14) in the conventional technology, not being influenced much by the adjacent members.

Thus, a work of locating the position of the nuclear fuel assembly 3 after refueling the nuclear fuel assembly 3 in the nuclear reactor vessel 1 and inserting the nuclear fuel assembly guide rod 3a into the second control rod insertion hole 131 can be performed easily and quickly. That is, even when the position alignment state of the nuclear fuel assembly 3 becomes inaccurate, because a range of allowance increases as much as an increment of the inner diameter of the lower end of the second control rod insertion hole 131, the nuclear fuel assembly guide rod 3a can be inserted in the second control rod insertion hole 131. When the nuclear fuel assembly guide rod 3a can be inserted in the second control rod insertion hole 131, a control rod connected to the control rod assembly connecting shaft 6 can be well inserted in the nuclear fuel assembly 3 without any damage to the nuclear fuel assembly 3.

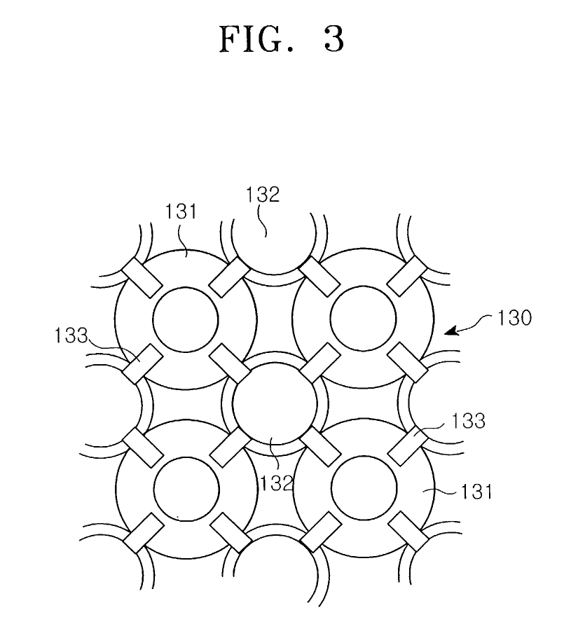

In the meantime, as shown in FIG. 3, second cooling water paths 133 connecting the first cooling water paths 132 and the second control rod insertion holes 131 which are adjacent to each other in a lateral direction can be formed at the bottom surface of the nuclear fuel alignment plate 130. Since the fluidity of the cooling water is improved by the second cooling water paths 133, an efficiency of cooling the heat generated during the disintegration of the nuclear fuel assembly can be improved.

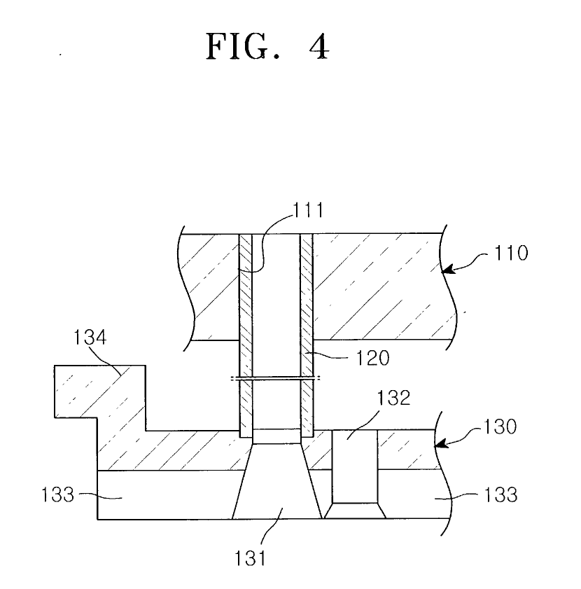

Referring to FIG. 4, an upper guide structure according to a second preferred embodiment of the present invention is described. In the upper guide structure according to a second preferred embodiment, the nuclear fuel alignment plate 130 is formed of a tray having a flange 134 extending upward and bent outside along the edge of the nuclear fuel alignment plate 130 according to the first preferred embodiment. The other elements are the same as those in the first preferred embodiment.

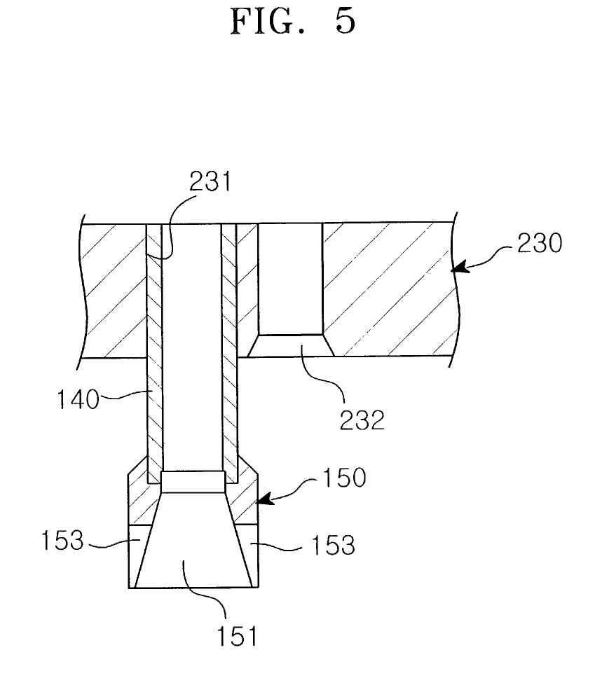

Referring to FIGS. 5 through 7, an upper guide structure according to a third preferred embodiment of the present invention, which is not shown, includes an upper guide cylinder, a support plate, and control rod assembly upper guide tubes, which have the same structure and function as those in the first preferred embodiment. In the present preferred embodiment, a nuclear fuel alignment plate 230 is installed at the lower end of the control rod assembly upper guide tube. The nuclear fuel alignment plate 230 has a plurality of second control rod insertion holes 231 formed at the positions corresponding to the control rod assembly upper guide tubes and a first cooling water path 232 formed between each of the second control rod insertion holes 231. A hollow control rod assembly lower guide tube 140 is inserted in each of the second control rod insertion holes 231 to protrude downward. A nuclear fuel assembly guide rod insertion body 150 into which the nuclear fuel assembly guide rod 3a is inserted is installed at the lower end of the control rod assembly lower guide tube 140. The guide rod insertion body 150 has a third control rod insertion hole 151 connected to the hollow control rod assembly lower guide tube 140 and having a funnel shape whose inner diameter increases to the lower end thereof, so that the nuclear fuel assembly guide rod 3a can be inserted even when a position alignment error of the nuclear fuel assembly 3 is great. Since the third control rod insertion hole 151 is formed in the guide rod insertion body 150, the maximum inner diameter of the third control rod insertion hole 151, that is, the inner diameter of the lowest end of the third control rod insertion hole 151, is not affected by the outer diameter of the control rod assembly lower guide tube 140 and can be formed greater than the outer diameter of the control rod assembly lower guide tube 140.

Thus, the nuclear fuel assembly guide rod 3a can be easily inserted into the third control rod insertion hole 151 having a funnel shape of the guide rod insertion body 150. In this case, the control rod can be well inserted into the nuclear fuel assembly 3 with any damage to the nuclear fuel assembly 3.

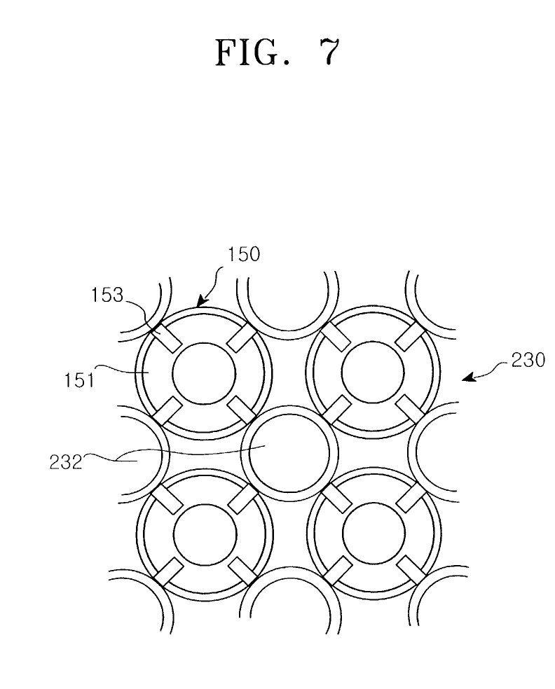

In the meantime, as shown in FIGS. 5 and 7, a third cooling water path 153 connected to the third control rod insertion hole 151 can be formed further at the lower surface of the nuclear fuel assembly guide rod insertion body 150. Thus, since the fluidity of the cooling water is improved by the third cooling water path 153, an efficiency of cooling the heat generated by the disintegration of the nuclear fuel assembly 3 can be improved.

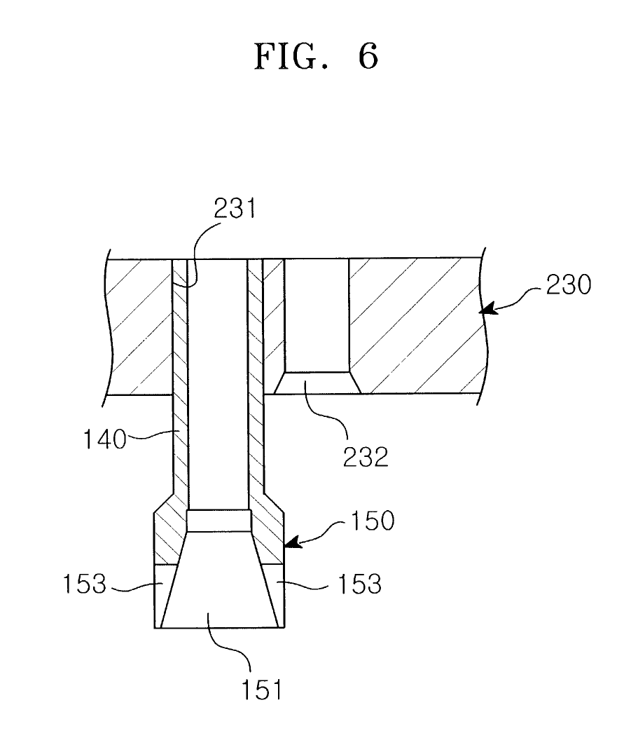

In the present preferred embodiment, although the nuclear fuel alignment plate 230 is preferably formed of a plate as in the first preferred embodiment, it can be formed of a tray as in the second preferred embodiment. Also, the nuclear fuel assembly guide rod insertion body 150 and control rod assembly lower guide tube 140 can be formed integrally as shown in FIG. 6.

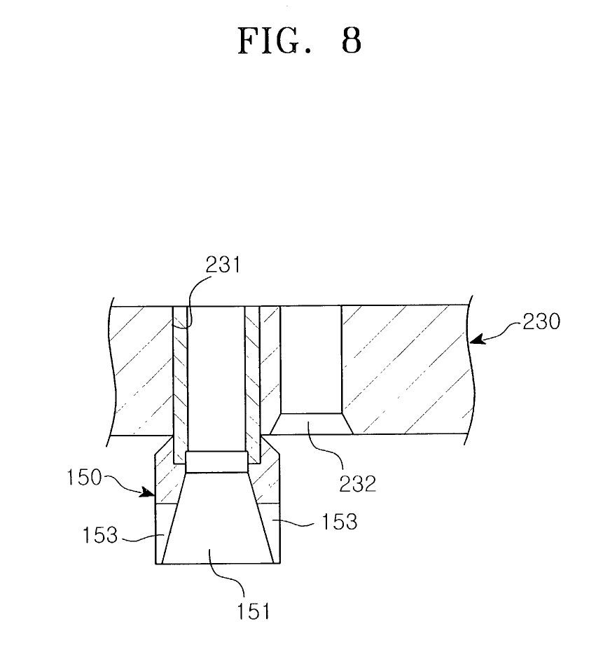

FIG. 8 shows an upper guide structure according a fourth preferred embodiment of-the present invention. In the present preferred embodiment, the structure of the upper guide structure is the same as that of the third preferred embodiment except that the upper end of the nuclear fuel assembly guide rod insertion body 150 contacts the bottom surface of the nuclear fuel alignment plate 230.

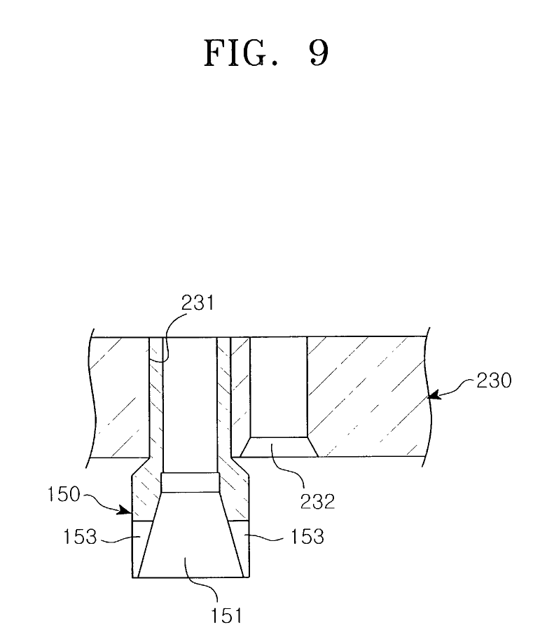

Also, in the present preferred embodiment, the nuclear fuel assembly guide rod insertion body 150 and control rod assembly lower guide tube 140 can be formed integrally as shown in FIG. 9.

As described above, in the upper guide structure for the simplification of a refueling procedure in a nuclear power plant according to the present invention, since a hole into which the nuclear fuel assembly guiding rod 3a is inserted has a funnel shape having an inner diameter which increases to the lower end thereof, after refueling the nuclear fuel assembly 3, a work of locating the position of the nuclear fuel assembly 3 and the nuclear fuel assembly guide rod 3a can be easily and quickly inserted into the second control rod insertion hole 131 or the third control rod insertion hole 151. Thus, the refueling time of the nuclear fuel assembly 3 can be remarkably reduced compared to the conventional structure. When the upper guide structure is reinstalled, the nuclear fuel assembly 3 can be prevented from being damaged.

Furthermore, in the present invention, since the second cooling water paths 133 or 153 are further provided to the nuclear fuel alignment plate 130 or the nuclear fuel assembly guide rod insertion body 150, in addition to the first cooling water paths 132 or 232, to facilitate flow of the cooling water of a high temperature and pressure, the heat generated during the disintegration of the nuclear fuel assembly 3 can be effectively cooled down so that stability of a nuclear reactor can be improved.

What is claimed is:

1. An upper guide structure for simplification of a refueling procedure in a nuclear power plant, the upper guide structure comprising:
an upper guide cylinder inserted in an upper end portion of a core support barrel installed inside a nuclear reactor vessel to guide a control rod assembly;
a support plate installed at a lower end of the upper guide cylinder and having a plurality of first control rod insertion holes formed therein;
hollow control rod assembly upper guide tubes respectively installed in the first control rod insertion holes; and
a nuclear fuel alignment plate installed at lower ends of the control rod assembly upper guide tubes and including a plurality of second control rod insertion holes formed at positions corresponding to the control rod assembly upper guide tubes, each of the second control rod insertion holes having an inner diameter which increases to an lower end thereof so that the nuclear fuel assembly guide rod is inserted even when a position alignment error of the nuclear fuel assembly is great, and first cooling water paths formed between the second control rod insertion holes.

2. The upper guide structure as claimed in claim 1, further comprising second cooling water paths formed in a bottom surface of the nuclear fuel alignment plate to connect in a lateral direction the first cooling water paths and the second control rod insertion holes which are adjacent to each other.

3. The upper guide structure as claimed in claim 1, wherein the nuclear fuel alignment plate is formed to have a plate shape or tray shape which has a flange extending upward from en edge thereof and bent outside.

4. The upper guide structure as claimed in claim 2, wherein the nuclear fuel alignment plate is formed to have a plate shape or tray shape which has a flange extending upward from en edge thereof and bent outside.

5. An upper guide structure for simplification of a refueling procedure in a nuclear power plant, the upper guide structure comprising:
an upper guide cylinder inserted in an upper end portion of a core support barrel installed inside a nuclear reactor vessel to guide a control rod assembly;
a support plate installed at a lower end of the upper guide cylinder and having a plurality of first control rod insertion holes formed therein;
hollow control rod assembly upper guide tubes respectively installed in the first control rod insertion holes;
a nuclear fuel alignment plate installed at lower ends of the control rod assembly upper guide tubes and including a plurality of second control rod insertion holes formed at positions corresponding to the control rod assembly upper guide tubes, and first cooling water paths formed between the second control rod insertion holes;
hollow control rod assembly lower guide tubes respectively inserted in the second control rod insertion holes to protrude downward; and
nuclear fuel assembly guide rod insertion bodies provided at lower ends of the control rod assembly lower guide tubes to connect the hollow control rod assembly lower guide tubes, and having third control rod insertion holes formed to have an inner diameter increasing to a lower end thereof so that the nuclear fuel assembly guide rod is inserted even when a position alignment error of the nuclear fuel assembly is great.

6. The upper guide structure as claimed in claim 5, wherein third cooling water paths connected to the third control rod insertion holes are formed in a bottom surface of the nuclear fuel assembly guide rod insertion bodies.

7. The upper guide structure as claimed in claim 5, wherein upper ends of the nuclear fuel assembly guide rod insertion bodies contact the bottom surface of the nuclear fuel alignment plate.

8. The upper guide structure as claimed in claim 5, wherein the nuclear fuel assembly guide rod insertion bodies are integrally formed with the control rod assembly lower guide tubes.

9. The upper guide structure as claimed in claim 6, wherein the nuclear fuel assembly guide rod insertion bodies are integrally formed with the control rod assembly lower guide tubes.

10. The upper guide structure as claimed in claim 7, wherein the nuclear fuel assembly guide rod insertion bodies are integrally formed with the control rod assembly lower guide tubes.
